(19) United States
(12) Patent Application Publication
(10) Pub. No.: US 2008/0141555 A1
(43) Pub. Date: Jun. 19, 2008

(54) DRYER HOUSING AND VENTING ARRANGEMENT FACILITATING VENTING OPTIONS

(75) Inventors: Bradley Steven Hoogendoorn, Webster City, IA (US); Michael Paul Ricklefs, Webster City, IA (US); Steven John Joerger, Ames, IA (US); Barry Eugene Gilman, Webster City, IA (US); Brian Douglas Ripley, Webster City, IA (US); Lee Allen Roose, Webster City, IA (US)

Correspondence Address: BANNER & WITCOFF, LTD.;ATTORNEYS FOR CLIENT NOS. 006912 AND 026912, 1100 13th STREET, N.W., SUITE 1200, WASHINGTON, DC, 20005-4051, US

(73) Assignee: Electrolux Home Products, Inc., Cleveland, OH (US)

(21) Appl. No.: 11/611,458

(22) Filed: Dec. 15, 2006

(51) Int. Cl. F26B 19/00

(52) U.S. Cl. 34/235

(57) ABSTRACT

A laundry dryer is configured to facilitate multiple venting arrangements, including side venting. A rear wall of the dryer includes a recessed region that extends width-wise along a lower portion of the rear wall, below an inwardly directed step and a deep tray of the rear wall panel. The dryer includes sidewall panels having a generally rectangular cut-away portion located at the respective lower rear corner thereof, in general registry with opposite ends of the recessed region. This arrangement allows the dryer to vent to either the left or right side, or downwardly to the floor, along the exterior of the housing, but within the dryer footprint, without requiring any modifications to the housing or internal vent passage. In addition, the dryer may include a telescoping vent tube extendible beyond the rear wall of the dryer to facilitate connection of an exterior vent extension during dryer installation, and retractable back into the housing.

### FIELD OF THE INVENTION

The present invention relates to the field of laundry dryers. In particular, the invention concerns exhaust air venting arrangements for laundry dryers.

### BACKGROUND OF THE INVENTION

Conventional laundry dryers generally include an exhaust vent passage to allow hot air and water vapor to be exhausted from the dryer drum. The vent passage typically comprises a duct which incorporates a lint trap and which extends from a blower arranged to pull heated air through the dryer drum. A vent tube typically extends from the duct rearwardly to exit at the rear side of the dryer. The vent tube typically exits the dryer through an aperture provided in the generally flat rear wall, where it connects to a vent tube extension coupling (e.g., elbow). The coupling is connected to a length of extension tubing that directs the exhaust airflow upward, downward or to the side, external of the dryer, as dictated by the particular installation. Such a venting arrangement requires the vent extension tubing to extend substantially wholly outside the footprint of the dryer, at the rear side of the dryer. As a result, additional space, particularly depth, is required to accommodate the dryer and the vent extension tubing.

In an alternate conventional arrangement of a laundry dryer, the vent tube exits through the sidewall of the dryer. In such an arrangement, the vent ducting extends from the dryer drum to a lint trap, and from the lint trap to an interior length of tubing that exits the dryer through an aperture in the drying housing sidewall. In order to provide the option to side vent in this manner, a portion of the sidewall of the dryer is made removable, typically by providing a circular knock-out. In addition to the aesthetic detraction that such a knock-out can create, and the labor required to remove the knock-out if it is to be used, this approach generally requires the owner or a technician to enter the dryer housing to re-route the interior vent tube through the aperture in the sidewall, typically with an adapter kit. This can lead to safety concerns, as well as potential mechanical problems and warranty issues, due to the alterations made inside the dryer.

Laundry dryers have been proposed that provide additional internal space to accommodate an exhaust vent. For example, U.S. Pat. No. 3,291,467 to Erickson discloses a dryer having a combustion chamber that is slanted upwardly. This arrangement allows for minimal contact between the flame and the walls of the combustion chamber and provides adequate space below the combustion chamber to permit an exhaust duct to pass directly underneath the chamber to facilitate the provision of side venting of the dryer. As in the case of a knock-out, however, this arrangement requires that an aperture (or knock-out for an aperture) be provided in the dryer housing sidewall, which may not be used in the event rear venting is elected.

### SUMMARY OF THE INVENTION

Dryer housing configurations and venting arrangements in accordance with aspects of the present invention can provide an economical, space-efficient and aesthetic alternative to conventional dryer venting arrangements as described above.

In accordance with an aspect of the invention, a laundry dryer includes a drying chamber contained within a housing. The housing comprises a rear wall structure and a pair of side wall structures. The dryer also includes an exhaust vent passage provided in fluid communication with the drying chamber for exhausting heated air and water vapor from the drying chamber. The exhaust vent passage extends within the housing to an aperture provided in the rear wall structure. The rear wall structure is configured to form a width-wise extending recessed region under an overlying portion of the rear wall structure. An aperture in the wall structure opens into this region. The width-wise extending recessed region serves to accommodate therein a substantial portion of an exterior exhaust vent extension, and to permit the exterior exhaust vent extension to extend selectively, and as a matter of choice during installation, toward either side of the dryer, with the exterior vent tube extension portion residing within the footprint of the dryer.

In a further aspect, the invention is embodied in a laundry dryer including a drying chamber and a housing containing the drying chamber. The housing includes a sidewall portion and a rear wall portion. A vent passage is provided for exhausting heated air and water vapor from the drying chamber. The passage includes a telescoping exhaust vent tube provided in fluid communication with the drying chamber. In one embodiment, the telescoping vent tube includes a main section that is slidably coupled to a collar section and which extends from the collar section to an aperture provided in the dryer housing. The main section is preferably extensible out of the housing through the aperture, and retractable to a position substantially wholly contained within the housing.

The above and other objects, features and advantages of the present invention will be readily apparent and fully understood from the following detailed description of preferred embodiments, taken in connection with the appended drawings.

### BRIEF DESCRIPTION OF THE DRAWINGS

FIG. 1 is a side elevational view of one embodiment of a dryer in accordance with an aspect of the present invention.

FIG. 2 is a bottom rear perspective view of the dryer of FIG. 1, showing a recess in the rear wall portion in accordance with an aspect of the invention.

FIG. 3 is a rear elevational view of the dryer of FIG. 1.

FIG. 4 is a side elevational view corresponding to FIG. 1, but with a side panel omitted to reveal interior structure of the dryer.

FIG. 5 is a diagrammatic cross-sectional view of a dryer including a telescoping vent tube arrangement in accordance with a further aspect of the invention, the tube being shown in a retracted position

FIG. 6 is a diagrammatic cross-sectional view of a dryer including a telescoping vent tube arrangement in accordance with a further aspect of the invention, the tube being shown in an extended position.

FIG. 7 is a cross-sectional view table taken on line 7-7 in FIG. 5.

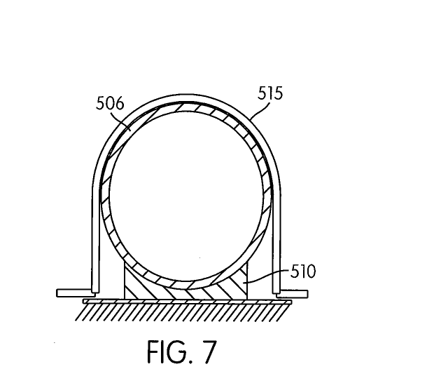

### DETAILED DESCRIPTION OF PREFERRED EXEMPLARY EMBODIMENTS

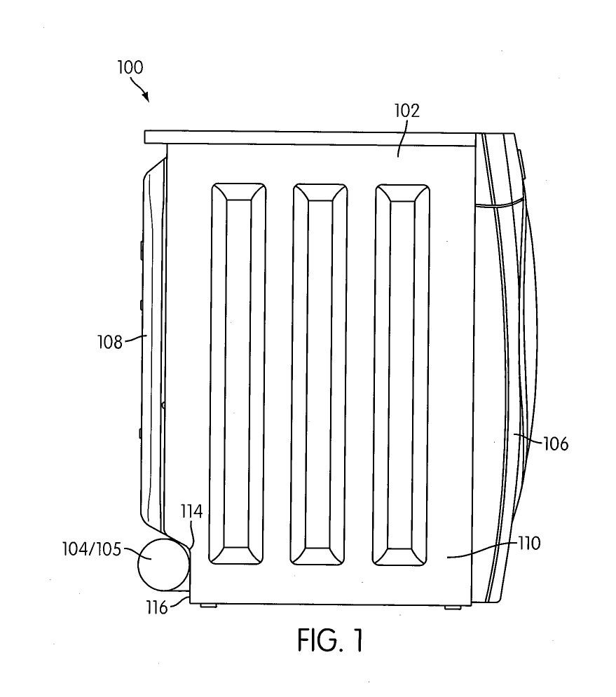

FIG. 1 illustrates an exemplary embodiment of a laundry dryer in accordance with the present invention. As shown, the dryer 100 includes a housing 102. Housing 102 generally includes a front wall panel 106, a rear wall panel 108 and two sidewall panels 110, 112. The sidewall portions 110, 112 and rear wall 108 may be formed of any suitable material, such as stamped metal.

As will be described in further detail, housing 102 contains a drying chamber and means for supplying heated air to the drying chamber, as well as a venting arrangement for exhausting heated air and water vapor from the drying chamber. As seen in FIG. 1, the venting arrangement may include, exteriorly, a vent tube extension coupling elbow 104 and a vent extension tube 105. Coupling elbow 104 is used to transition the vent passage from the interior to the exterior of the dryer housing. Elbow 104 may be a standard 90° elbow sized and configured to couple on one end to the outlet of an internal segment (vent tube) of the vent passage, and at its other end to vent extension tube 105. Tube 105 (and elbow 104) may extend to either side of the dryer, or downwardly toward the dryer support surface, substantially within the footprint of the dryer.

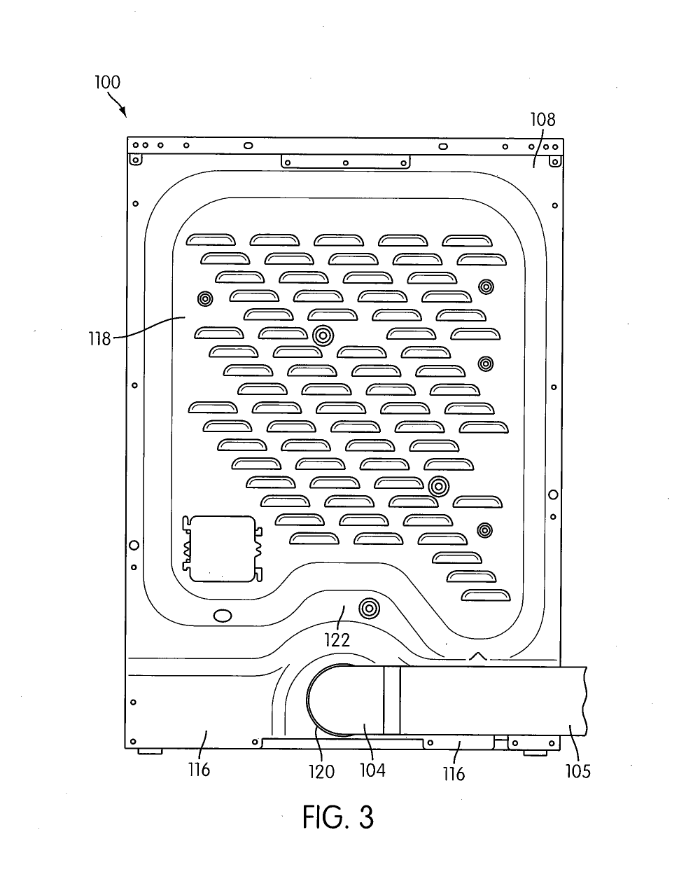

With further reference to FIGS. 1-3, the rear wall panel 108 of the laundry dryer 100 is configured to form a recessed region 116 running along the width of the laundry dryer 100 and adjacent the lower rearward corner. Region 116 is formed under an overlying portion of rear wall panel 108. Recessed region 116 provides a space within which exhaust vent extension coupling 104, and vent extension tube 105 connected thereto, may run, from an aperture 120 provided in the rear wall panel to either sidewall of the dryer, along the exterior of the rear wall 108. Preferably, recessed region 116 is sized and configured so as to permit extension coupling 104 and vent tube extension 105 to reside substantially within the footprint of the dryer. It will be appreciated, however, that as long as some substantial portion of the vent tube extension and/or vent tube coupling are accommodated within the footprint of the dryer, and which would otherwise contribute to the dryer installation depth, space-saving benefits may be realized. As indicated in the Background section, conventional dryers typically include a vent extension coupling, and an attached vent extension tube, that protrude from the rear of the dryer wholly or substantially, outside of the footprint of the dryer housing. Such arrangements require the dryer to be spaced away from a backing wall, typically a distance at least equal to the diameter of the vent extension tube, thus taking up additional space which, in some installations, may be scarce.

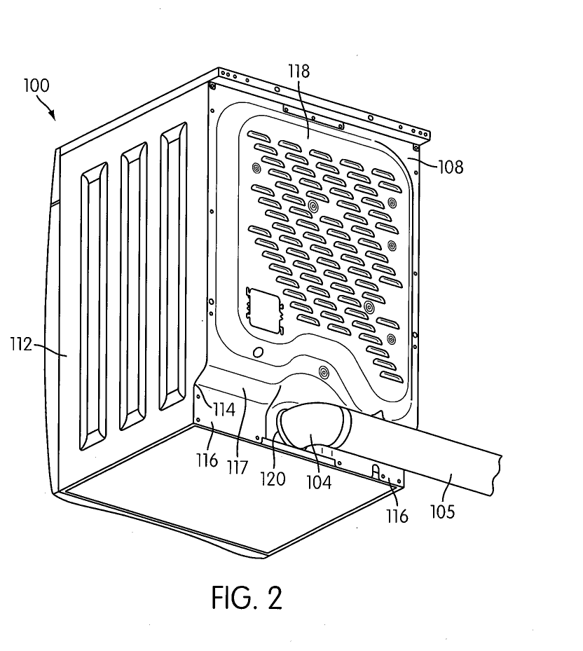

In the illustrated embodiment, aperture 120, where extension coupling 104 is attached to the outlet of an interior vent tube, is centrally located along recessed region 116 between the two sides, although this is not necessarily the case. While the vent extension coupling 104 is shown in FIG. 2 extending toward the right, it will be understood that the vent could readily be rotated or otherwise repositioned to extend to the opposite side of the dryer 100, or be directed downwardly toward the floor (dryer support surface). While in the illustrated embodiment, vent extension coupling 104 is provided separately from the vent extension tube which is attached thereto, a single vent extension structure could be provided instead. Herein, and except otherwise indicated, the term “exterior exhaust vent extension” is used in the general sense to refer to a structure that continues, exteriorly, the exhaust vent passage segment which extends within the dryer housing. Such a structure may include (but is not limited to) one or both of a vent extension coupling 104, and a vent tube 105, as illustrated.

In addition, and as a compliment, to recessed region 116, each of the side wall portions 110, 112 of the dryer housing 102 are preferably formed with a “notch” 114 in the bottom, rear corner, as shown in FIGS. 1 and 2. This notched or cut-away region 114 preferably has a side profile substantially corresponding to the side profile of recessed region 116 of the rear wall panel, and is positioned in registry with the recessed region so as to allow a vent extension tube to exit the recessed region (and the dryer footprint) at either side of the dryer. In conjunction with recessed region 116, sidewall cut away regions 114 provide a side-venting installation that permits the dryer to be positioned up against a wall with little to no extra spacing (depth) required to accommodate the vent extension tube and elbow. Advantageously, such side-venting can be accomplished without the need for a technician to enter the housing and/or remove a portion of the sidewall.

As illustrated, recessed region 116 is formed in part by an inward step 117 of the rear wall panel 108, which spans the entire distance between side wall portions 110, 112. Step 117, and sidewall cut-aways 114, are generally deep enough to accommodate approximately one half of the width of a standard sized exhaust vent extension, which may have an outer diameter of, e.g., 4″±⅛″. An additional overhang structure may be created by a stamped or otherwise formed deep tray 118 of the rear wall panel 108. As illustrated, this tray may occupy less than the entire height and width of the rear wall structure. In and of themselves, such rear panel tray structures are conventionally used to permit a greater drying drum depth without a corresponding increase in the depth of the dryer framework. In the exemplary inventive arrangement, however, the depths of the tray 118 and recessed region 116 are, collectively, sufficient to accommodate within the dryer housing footprint substantially the entire rearwardly extending depth of the vent extension elbow and width (diameter) of the vent extension tube.

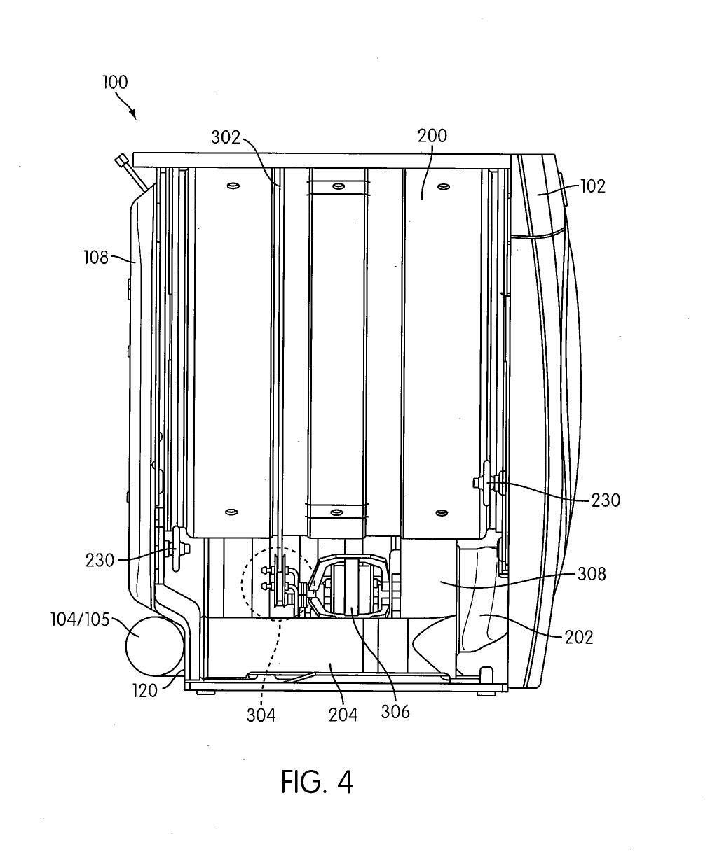

Referring now to FIG. 4, the drying chamber or drum 200 of dryer 100 is visible. The drum 200 is rotated by way of a drive belt 302 extending around the drum, which is driven by a motor 306 and maintained at proper tension by a pulley system 304. Drum 200 is situated on rollers 230 to allow for the rotation of drum 200 thereon, and the tumbling of laundry therein, to facilitate drying in a conventional fashion. A blower assembly 308, which may also be commonly driven by motor 306, is positioned beneath the dryer drum 200. Blower 308 has an impeller that serves to create a vacuum which pulls air from the exterior of the dryer, through a conventional heating chamber (not shown) and into the dryer drum 200. Within the dryer drum, the heated air passes through and over the tumbling wash load and evaporates moisture therein. The air is then expelled from the dryer drum through the exhaust air vent path. In the illustrated embodiment, the exhaust air vent path extends through a lint trap positioned adjacent the dryer drum access opening, into an associated duct 202 and through the blower 308 that connects with a vent tube 204. Vent tube 204 extends rearwardly through the housing to aperture 120 provided in the rear wall panel 108. As described previously, a vent extension coupling elbow 104 may extend through this outlet 120 and permit connection of a vent tube extension 105 portion thereto, that may run to the right or left, along the recessed region of the exterior of the rear wall 108, or downwardly toward the floor, while remaining substantially within the footprint of the dryer 100.

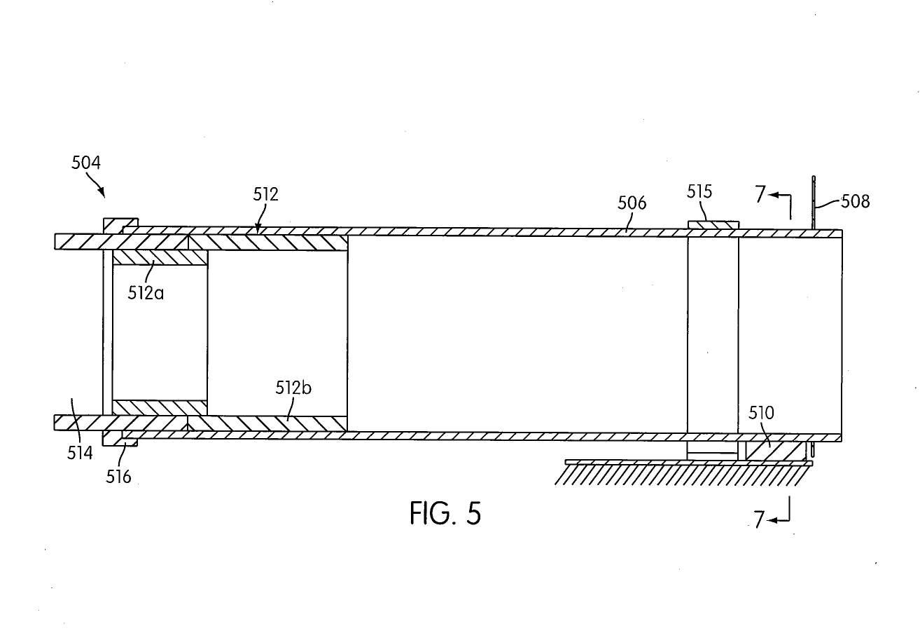

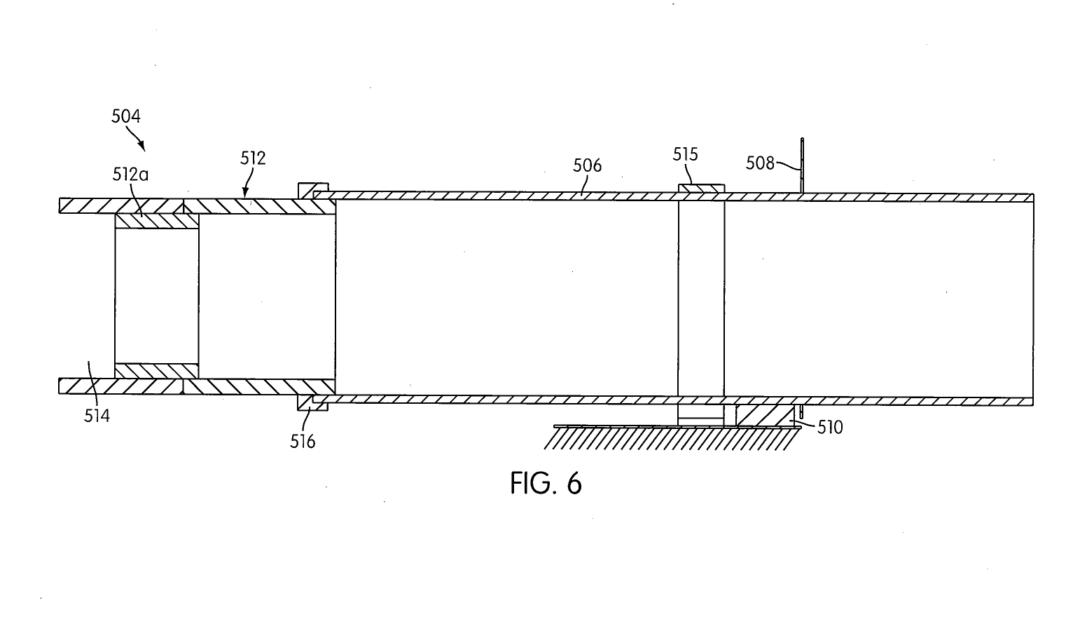

FIG. 5 depicts a further aspect of the invention, namely a telescoping dryer vent tube 504, that may be used in lieu of the fixed length tube 204 shown in FIG. 4. Vent tube 504 generally includes a fixed section 512 provided with a reduced diameter attachment section 512a which may be press-fit into an end opening of a blower duct 514, or other vent path segment. Fixed section 512 also includes a collar section 512b of cylindrical tubing upon which a longer and slightly larger diameter main tubing section 506 is telescopically moveable. Tubing 506 is telescopically, slidably moveable along collar section 512b and adjoining duct segment 514, from a position placing its free end generally flush with or slightly protruding from the backsheet, (i.e., rear wall panel 508 of the dryer, as seen in FIG. 5) to a position in which the end of the tubing 506 protrudes from the backsheet several inches or more (as seen in FIG. 6). This telescoping extension facilitates the attachment of a vent tube extension and/or vent tube extension coupling elbow during dryer installation. In order to form this connection, the main section 506 of the vent tube 504 may be pulled out of the housing, making the attachment location more accessible and providing additional circumferential surface area at the end of tubing 506 to make the connection. Once the connection has been made, the main section 506 may be pushed back into the housing to minimize the installation depth of the dryer.

A cushioning spacer block 510 may be positioned beneath the main section 506 and in sliding contact therewith, to support and keep level the main section 506 within the dryer housing, as well as to facilitate a smoothly sliding telescoping action. As best seen in FIG. 6, spacer block 510 may have an arcuate shape corresponding to the cylindrical shape of main section 506. Lateral and vertical tube displacement during sliding can be restricted further by an arcuate strap 515 extending over the tube and having its ends secured to the floor of the dryer housing. An annular seal 516 is attached to the main section 506 and overlaps the moveable circumferential joint between tubing main section 506 and collar section 512b in order to provide a generally fluid-tight seal that prevents significant leakage of the exhausted air and water vapor within the dryer housing.

The extension and retraction of the main section 506 are performed by sliding the main section 506 along fixed section 512 the desired distance, in a telescoping manner. The extensibility distance may be increased or decreased by varying the length of collar section 512b upon which main tubing section 506 slides. Additional nested telescoping sections could also be provided to increase the extensibility of the vent tube 504.

The present invention has been described in terms of preferred and exemplary embodiments thereof. Numerous other embodiments, modifications and variations within the scope and spirit of the appended claims will occur to persons of ordinary skill in the art from a review of this disclosure.

1. A laundry dryer comprising:
a drying chamber;
a housing containing said drying chamber, said housing comprising a rear wall structure and a pair of sidewall structures; and
an exhaust vent passage provided in fluid communication with said drying chamber for exhausting heated air and water vapor from the drying chamber;
wherein, said exhaust vent passage extends within the housing to said rear wall structure, said rear wall structure being configured so as to form an exterior width-wise extending recessed region under an overlying portion of said rear wall structure, said exhaust vent passage extending to an aperture provided in the rear wall structure, which opens into the width-wise extending recessed region, said width wise extending recessed region serving to accommodate therein at least a half portion of a lateral width of an exterior exhaust vent extension and to permit the exterior exhaust vent extension to extend selectively, and as a matter of choice during installation, toward either side of the dryer, with said at least a half portion of said lateral width of the exterior exhaust vent extension residing within the footprint of the dryer.

2. A laundry dryer according to claim 1, wherein said width-wise extending recessed region is open on a lower side thereof, so as to permit the exterior exhaust vent extension to extend downwardly toward a floor, substantially within the footprint of the dryer.

3. A laundry dryer according to claim 1, wherein each of said pair of sidewall structures comprises a generally rectangular wall panel provided with a cut-away region corresponding in location to opposite ends of the recessed region.

4. A laundry dryer according to claim 3, wherein the cut-away regions are provided at respective lower rear corners of the sidewall structures.

5. A laundry dryer according to claim 1, wherein said rear wall structure comprises an inward step spanning the distance between the sidewall structures and forming a portion of said overlying portion of said rear wall structure.

6. A laundry dryer according to claim 5, wherein said rear wall structure comprises a protruding tray structure having a depth dimension extending rearwardly beyond rearward edges of said side wall structures so as to form a portion of said overlying portion of said rear wall structure.

7. A laundry dryer according to claim 1, wherein said recessed region, and at least one of said sidewall structures, are configured to permit the exhaust vent tube extension portion to extend selectively, and as a matter of choice during installation, to at least one side of the dryer, substantially within the footprint of the dryer, and to exit the footprint at said at least one side.

8. A laundry dryer comprising:
a drying chamber;
a housing containing said drying chamber, said housing comprising a rear wall structure and a pair of sidewall structures; and
an exhaust vent passage provided in fluid communication with said drying chamber for exhausting heated air and water vapor from the drying chamber;
wherein, said exhaust vent passage extends within the housing to said rear wall structure, said rear wall structure being configured so as to form a recessed region outside of the housing, said exhaust vent passage extending to an aperture provided in the rear wall structure which open into the recessed region, said recessed region serving to accommodate therein at least a half portion of a lateral width of an exhaust vent extension and to permit the exhaust vent extension to extend selectively, and as a matter of choice during installation, downwardly toward a floor, with said at least a half portion of said lateral width of the exhaust vent extension residing within a footprint of the dryer.

9. A laundry dryer according to claim 8, wherein said recessed region, and at least one of said sidewall structures, are configured to permit the exhaust vent extension to extend selectively, and as a matter of choice during installation, to at least one side of the dryer, substantially within the footprint of the dryer, and to exit the footprint at said at least one side.

10. A laundry dryer according to claim 8, wherein said exhaust vent passage comprises a telescoping exhaust vent tube, said tube including a main section slidably coupled to a collar section and extending from the collar section to said aperture, said main section being extensible out of the housing through said aperture, and retractable to a position substantially wholly contained within the housing.

11. (canceled)

12. The laundry dryer of claim 17 wherein, said telescoping exhaust vent tube includes a main section slidably coupled to a collar section and extending from the collar section to an aperture provided in a wall portion of the housing.

13. The laundry dryer of claim 12 said main section being extensible so as to extend out of said housing through said aperture, and retractable to a position substantially wholly contained within the housing.

14. The laundry dryer of claim 10 further comprising a seal connected to a first end of the main section of the exhaust vent tube, for providing a slidable seal between said main section and said collar section.

15. The laundry dryer of claim 12 wherein the collar section is directly coupled to a blower outlet of the dryer.

16. The laundry dryer of claim 15, wherein the collar section is press fit into the blower outlet.

17. The laundry dryer according to claim 1, wherein said exhaust vent passage comprises a telescoping exhaust vent tube.

18. The laundry dryer of claim 1, further comprising said exterior exhaust vent extension, a lengthwise portion of which is accommodated within said width-wise exterior recess region toward a side of the dryer, with at least a half portion of a lateral width of said lengthwise portion residing within a footprint of said dryer.

19. The launder dryer of claim 18, wherein said lateral width is accommodated within said recess so as to reside substantially completely within the footprint of the dryer.

20. The laundry dryer of claim 8, further comprising said exterior exhaust vent extension, a lengthwise portion of which is accommodated within said exterior recess region downward to the floor, with at least a half portion of a lateral width of said lengthwise portion residing within a footprint of said dryer.

21. The launder dryer of claim 20, wherein said lateral width is accommodated within said recess so as to reside substantially completely within the footprint of the dryer.
